(19) United States
(12) Patent Application Publication
(10) Pub. No.: US 2026/0228872 A1
(43) Pub. Date: Aug. 6, 2026

(54) INSPECTION SYSTEM

(71) Applicant: NEC Corporation, Tokyo (JP)

(72) Inventor: Michiaki INOUE, Tokyo (JP)

(73) Assignee: NEC Corporation, Tokyo (JP)

(21) Appl. No.: 19/150,927

(22) PCT Filed: Feb. 1, 2023
(86) PCT No.: PCT/JP2023/003273

§ 371 Date: Jul. 25, 2025

(51) Int. Cl. G06T 7/00; G01N 15/04; G06T 5/73; G06T 7/20; H04N 23/68

(52) U.S. Cl. CPC G06T 7/0002; G01N 15/04; G06T 5/73; G06T 7/20; H04N 23/685; G06T 2207/10016; G06T 2207/30241

(57) ABSTRACT

An inspection system inspecting the presence or absence of foreign matter in a liquid sealed in a container includes: a flow inducing means for causing the liquid in the container to flow; a minute vibration applying means for causing the container where the liquid is flowing to minutely vibrate; and a detecting means for detecting and tracking suspended matter present in the liquid in the minutely vibrating container in a time-series image obtained by continuously capturing the liquid with a camera, and detecting the presence or absence of foreign matter based on a movement trajectory of the tracked suspended matter.

### TECHNICAL FIELD

The present invention relates to an inspection system, an inspection method, and a recording medium.

### BACKGROUND ART

As a system that inspects the presence of foreign matter in a liquid sealed in a container, there is a proposed system that observes the behavior of suspended matter in the liquid in the container after making the liquid flow and determines as a bubble when the suspended matter ultimately floats up and determines as foreign matter when the suspended matter subsides (refer to, for example, Patent Literature 1).

### CITATION LIST

### Patent Literature

Patent Literature 1: WO2021/214994

### SUMMARY OF INVENTION

### Technical Problem

There are many types of foreign matter that may mix in the liquid, and their specific gravities relative to the liquid are various. Foreign matter with low specific gravity, such as a fiber fragment, takes time to exhibit behavior specific to foreign matter, such as subsidence, compared to foreign matter with high specific gravity, such as a metal fragment and a glass shard. Therefore, there has been a problem of decreased inspection efficiency. The inspection efficiency significantly decreases especially when dealing with a high-viscosity liquid.

An object of the present invention is to provide an inspection system that solves the problem of decreased inspection efficiency.

### Solution to Problem

An inspection system as an aspect of the present invention is an inspection system inspecting presence or absence of foreign matter in a liquid sealed in a container, and the inspection system includes: a flow inducing means for causing the liquid in the container to flow; a minute vibration applying means for causing the container where the liquid is flowing to minutely vibrate; and a first detecting means for detecting and tracking suspended matter present in the liquid in the minutely vibrating container in a time-series image obtained by continuously capturing the liquid with a camera, and detecting presence or absence of foreign matter based on a movement trajectory of the tracked suspended matter.

An inspection method as another aspect of the present invention is an inspection method for inspecting presence or absence of foreign matter in a liquid sealed in a container, and the inspection method includes: causing the liquid in the container to flow; causing the container where the liquid is flowing to minutely vibrate; and detecting and tracking suspended matter present in the liquid in the minutely vibrating container in a time-series image obtained by continuously capturing the liquid with a camera, and detecting presence or absence of foreign matter based on a movement trajectory of the tracked suspended matter.

A non-transitory computer-readable recording medium as an aspect of the present invention has a program recorded thereon, and the program includes instructions for causing a computer inspecting presence or absence of foreign matter in a liquid sealed in a container to execute processes to: cause the liquid in the container to flow; cause the container where the liquid is flowing to minutely vibrate; and detect and track suspended matter present in the liquid in the minutely vibrating container in a time-series image obtained by continuously capturing the liquid with a camera, and detect presence or absence of foreign matter based on a movement trajectory of the tracked suspended matter.

### Advantageous Effects of Invention

With the configuration as described above, the present invention enables shortening of the time until behavior specific to foreign matter such as subsidence is observed, thereby increasing inspection efficiency.

### BRIEF DESCRIPTION OF THE DRAWINGS

FIG. 1 is a schematic diagram showing an outline configuration of an inspection system that executes an inspection method according to a first example embodiment of the present invention.

FIG. 2 is an explanatory diagram of an example of a container to be inspected and a vibration direction in the first example embodiment of the present invention.

FIG. 3 is a block diagram showing an example of an information processing apparatus in the first example embodiment of the present invention.

FIG. 4 is a diagram showing an example configuration of a time-series image in the first example embodiment of the present invention.

FIG. 5 is a diagram showing an example configuration of corrected time-series image in the first example embodiment of the present invention.

FIG. 6 is a diagram showing an example configuration of tracking information in the first example embodiment of the present invention.

FIG. 7 is a diagram showing an example configuration of inspection result information in the first example embodiment of the present invention.

FIG. 8 is a flowchart showing an example of preprocessing in the inspection system in the first example embodiment of the present invention.

FIG. 9 is a flowchart showing an example of an inspection process performed by the inspection system on the container to be inspected in the first example embodiment of the present invention.

FIG. 10 is a block diagram showing an example of an information processing apparatus in a second example embodiment of the present invention.

FIG. 11 is a flowchart showing an example of an inspection process performed by the inspection system on the container to be inspected in the second example embodiment of the present invention.

FIG. 12 is an essential part configuration diagram of an inspection system in a fourth example embodiment of the present invention.

FIG. 13 is an essential part configuration diagram of an inspection system in a fifth example embodiment of the present invention.

FIG. 14 is a block diagram of an inspection system in a sixth example embodiment of the present invention.

### DESCRIPTION OF EXAMPLE EMBODIMENTS

### First Example Embodiment

First, a liquid to be inspected in a first example embodiment of the present invention will be described.

In general, liquid is divided into types of Newtonian fluid and non-Newtonian fluid, and non-Newtonian fluid is further divided into two types of shear thickening fluid and shear thinning fluid. Among them, shear thinning fluid has a characteristic (referred to as non-Newtonian viscosity characteristic) where the viscosity decreases as the applied deformation rate (shear rate) increases. Representative examples of shear thinning fluid are Bingham fluid (such as fresh cream and butter) and pseudoplastic fluid (such as polymer solution). Liquid with the non-Newtonian viscosity characteristic exhibits a decrease in viscosity as the applied deformation rate increases. Then, as the viscosity decreases, the subsidence rate of foreign matter such as a fiber fragment or a metal fragment with higher specific gravity than the liquid increases. Consequently, the time until behavior specific to foreign matter such as subsidence is observed can be shortened. Regarding the non-Newtonian viscosity characteristic, the viscosity returns to its original one when the applied deformation rate becomes equal to or less than a certain value (including zero). Therefore, in order to observe the behavior of suspended matter in a liquid with reduced viscosity by capturing with a camera device 6, it is required to capture with the camera device 6 while continuously applying minute vibrations to a container 2.

Liquid to be inspected in this example embodiment is a liquid that exhibits the non-Newtonian viscosity characteristic as described above. Any type of liquid that exhibits the non-Newtonian viscosity characteristic can be used. For example, the liquid may be a liquid medicine or even drinking water.

Next, the configuration and operation of the first example embodiment of the present invention will be described in detail.

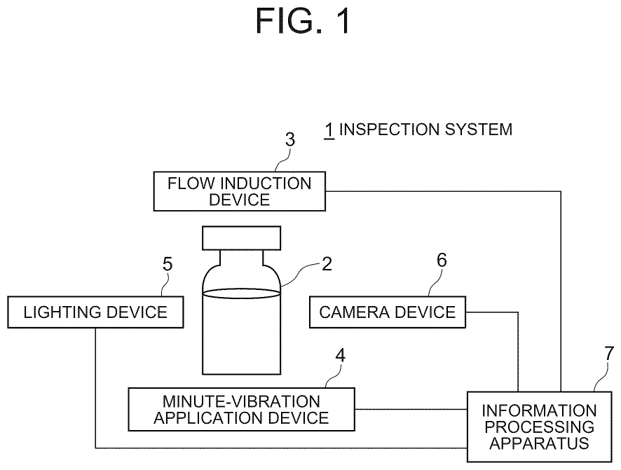

FIG. 1 is a schematic diagram showing an outline configuration of an inspection system 1 that executes an inspection method according to the first example embodiment of the present invention. Referring to FIG. 1, the inspection system 1 is a system that inspects the presence of foreign matter in a liquid sealed in the container 2. The inspection system 1 includes, as its main components, a flow induction device 3, a minute-vibration application device 4, a lighting device 5, the camera device 6, and an information processing apparatus 7.

The container 2 is a transparent or translucent substantially cylindrical container such as a glass bottle. Inside the container 2, a transparent or translucent liquid exhibiting the non-Newtonian viscosity characteristic is sealed and filled. As an example, the container 2 is a syringe or vial filled with a liquid medication that exhibits the non-Newtonian viscosity characteristic. There is a possibility that foreign matter is mixed in the liquid sealed in the container 2. Foreign matter may be, for example, a glass fragment, a metal fragment, a rubber piece, hair, a fiber piece, soot, and so forth. Among the above foreign matter, a glass fragment and a metal fragment have the highest specific gravity, hair, a fiber piece and soot have the lowest specific gravity, and a rubber fragment has an intermediate specific gravity between them. However, since any of the foreign matter has a specific gravity heavier than the specific gravity of the liquid sealed in the container 2, it sinks near the bottom surface of the container 2 and does not float when the liquid is in a stable state. Therefore, the inspection system 1 causes the flow induction device 3 to make the liquid in the container 2 flow, allowing the foreign matter to be observed as suspended matter.

The flow induction device 3 may be, for example, a device including a container grasping unit that grasps the container 2 in the upright posture, and a rotation mechanism unit that rotates the container grasping unit around an axis that is a central line passing through the center of the bottom surface to the center of the top of the container 2. Alternatively, the flow induction device 3 may be a device including a container grasping unit that grasps the container 2 in the upright posture, and a tilt mechanism unit that repeatedly performs an action of tilting the container grasping unit in such a manner that the axis of the container 2 is tilted in a predetermined direction and then returning it to the upright posture again. Additionally, any device capable of making the liquid sealed in the container 2 flow may be used as the flow induction device 3, regardless of its configuration.

The minute-vibration application device 4 is a device that minutely vibrated the container 2. The minute-vibration application device 4 is configured to minutely vibrates the container 2 along a previously determined minute-vibration trajectory. The minute-vibration trajectory is defined by a total of three parameters: a direction θ to minutely vibrate, a frequency f, and a displacement amount Δd.

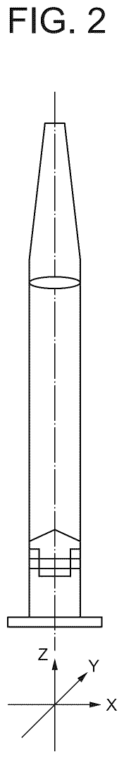

The direction θ to minutely vibrate is preferably a direction of shaking the entire liquid in the container 2 more uniformly. Such a direction can be determined almost based on the shape of the container 2. For example, as shown in FIG. 2, in a case where the container 2 is a long and thin syringe, it is desirable to shake it in a direction perpendicular to the cylindrical axis. That is to say, when the cylindrical axis of the stationary container 2 is the Z-axis and axes perpendicular thereto are the X-axis and Y-axis, it is desirable to set a direction parallel to the XY plane as the direction to minutely vibrate the container 2. The same applies to a bottle-shaped vial and the like. However, a trajectory to minutely vibrate is not limited to a straight line, and it may be a curve line such as an arc or an ellipse.

The frequency f of the minute vibrations and the displacement amount Δd determine the magnitude of kinetic energy applied to the liquid in the container by the minute vibrations. For a liquid with higher viscosity, it is desirable to set the value for f×Δd to be larger because it is desired to set the kinetic energy to be larger and reduce the viscosity. However, due to the limitation by the field of angle of the camera device 6, the demand for miniaturization of the inspection system, and so forth, it is not desirable to make the displacement amount Δd more than a certain level. Therefore, when the frequency f is equal to or less than a certain level, it is difficult to apply sufficient kinetic energy to the liquid. Consequently, the frequency f should be at least 10 Hz or higher, and preferably 100 Hz or higher. The frequency range of 100 Hz or higher may include or exclude the ultrasonic range.

Various configurations can be assumed for the minute-vibration application device 4 that minutely vibrated the container 2 along the minute-vibration trajectory. For example, the minute-vibration application device 4 may be a device including a container grasping unit that grasps the container 2 in the upright posture, and a reciprocating vibration mechanism unit that causes the container grasping unit to reciprocate and vibrate along the minute-vibration trajectory within a range of +Δd, −Δd at the frequency f. The reciprocating vibration mechanism unit may include, for example, a planar cam mechanism that converts the rotational motion of a rotary motor into reciprocating motion. Alternatively, the minute-vibration application device 4 may be a device including a container grasping unit that grasps the container 2 in the upright posture, and a reciprocating swing mechanism unit that reciprocates and swings the container grasping unit within a range of +α, −α (α is, for example, 90° or less) at the frequency f around an axis that is a center line passing through the center of the bottom surface to the center of the top of the container 2. Additionally, the minute-vibration application device 4 may be a device with any configuration as long as it is capable of minutely vibrating the container 2.

The container grasp unit that grasps the container 2 can be shared between the flow induction device 3 and the minute-vibration application device 4, or can be independent. By sharing the container grasp unit between the devices, it is possible to reduce the effort and time required for transferring the container 2 between the devices. Further, the rotation mechanism unit of the flow induction device 3 and the reciprocating rotation mechanism unit of the minute-vibration application device 4 may be common. That is to say, a rotation mechanism rotating the container 2 around an axis that is a center line passing through the center of the bottom surface to the center of the top of the container 2 may be used to induce the flow of the liquid by repeatedly rotating the container 2, for example, in +360° and −360° directions, and to apply minute vibrations by repeatedly rotating the container 2, for example, in +90° and −90° directions.

The lighting device 5 is configured to apply illumination light onto the liquid flowing inside the container 2 to be inspected. The lighting device 5 is, for example, a spot light source of a size capable of illuminating the entire liquid inside the container 2 to be inspected. The lighting device 5 is installed on the same side as or opposite side to the camera device 6 when viewed from the container 2. In other words, the illumination by the lighting device 5 is either transmitted lighting or reflected lighting. In the following, it will be explained assuming that the lighting device 5 is installed on the opposite side to the camera device 6 when viewed from the container 2.

The camera device 6 is an image capturing device that continuously captures the liquid flowing within the container 2 at a predetermined frame rate from a fixed position on the opposite side to the side where the lighting device 5 is installed when seen from the container 2. The predetermined frame rate may be less than 100 fps or may be equal to or more than 100 fps, for example. The camera device 6 may be configured with a color camera or monochrome camera equipped with a CCD (Charge-Coupled Device) image sensor or CMOS (Complementary MOS) image sensor having a pixel capacity of several million pixels, for example. The exposure time of the camera device 6 is sufficiently short compared to the capture cycle. The camera device 6 is connected to the information processing apparatus 7 via wired or wireless connection. The camera device 6 is configured to transmit captured time-series image, along with information indicating the capture time and the like, to the information processing apparatus 7.

The information processing apparatus 7 is configured to perform image processing on the time-series image captured by the camera device 6 and inspect for the presence of foreign matter in the liquid sealed in the container 2. The information processing apparatus 7 is connected to the flow induction device 3, the minute-vibration application device 4, the lighting device 5, and the camera device 6 by wired or wireless connection.

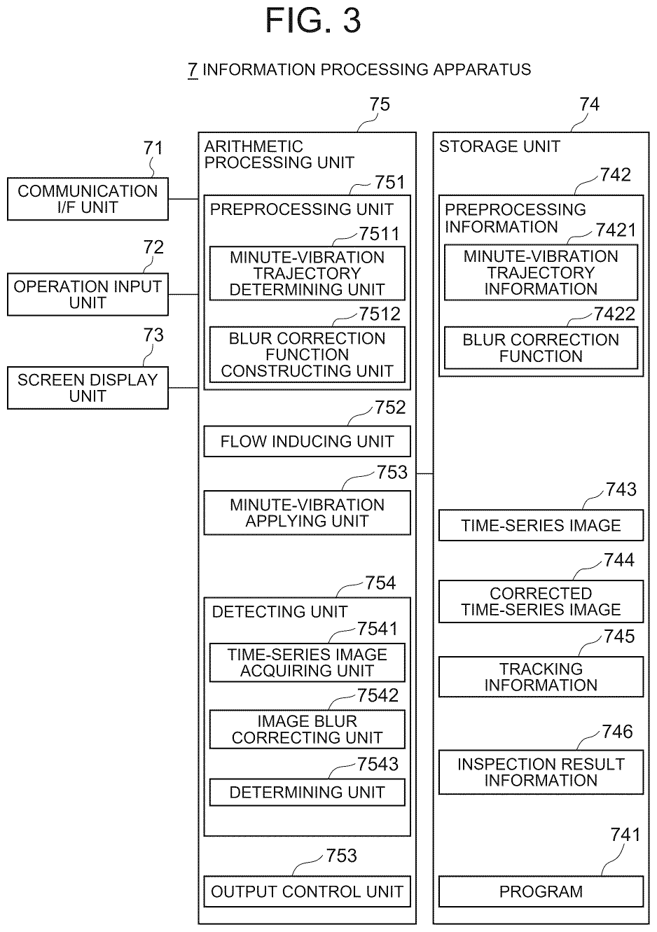

FIG. 3 is a block diagram showing an example of the information processing apparatus 7. Referring to FIG. 3, the information processing apparatus 7 includes a communication I/F unit 71, an operation input unit 72, a screen display unit 73, a storage unit 74, and an arithmetic processing unit 75.

The communication I/F unit 71 is configured with a data communication circuit and is configured to perform data communication via wired or wireless connection with the flow induction device 3, the minute-vibration application device 4, the lighting device 5, the camera device 6, and other external devices not shown in the drawings. The operation input unit 72 is configured with an operation input device such as a keyboard and a mouse, and is configured to detect an operation by the operator and output it to the arithmetic processing unit 75. The screen display unit 73 includes a screen display device such as an LCD (Liquid Crystal Display) or a PDP (Plasma Display Panel), and is configured to display various information including inspection results on the screen in response to instructions from the arithmetic processing unit 75.

The storage unit 74 is configured with one or more storage devices of one or multiple types, such as a hard disk and memory, and is configured to store processing information and a program 741 necessary for a variety of processing in the arithmetic processing unit 75. The program 741, which is a program enabling various processing units by being loaded and executed by the arithmetic processing unit 75, is previously loaded from an external device or a recording medium, which is not shown in the drawings, via a data input/output function such as the communication I/F unit 71, and is stored into the storage unit 74. Major processing information stored in the storage unit 74 includes preprocessing information 742, time-series image 743, corrected time-series image 744, tracking information 745, and inspection result information 746.

The preprocessing information 742 includes a variety of information determined prior to the inspection of the container 2. In this example embodiment, the preprocessing information 742 includes minute-vibration trajectory information 7421 and a blur correction function 7422.

The minute-vibration trajectory information 7421 is information representing a trajectory where the minute-vibration application device 4 minutely vibrates the container 2. Specifically, the minute-vibration trajectory information 7421 is defined by a total of three parameters: a direction θ to minutely vibrate, a frequency f, and a displacement amount Δd.

The blur correction function 7422 is a function used to correct blur in an image captured by the camera device 6. An image obtained by capturing the minutely vibrating container 2 with the camera device 6 experiences image blur due to movement of an object to be shot. The blur thus occurring is called motion blur. A degraded image caused by motion blur is generally represented by the following equation;

$$g ( x , y ) = h ( x , y ) ⋆ ’ f ( x . y ) \qquad ( 1 )$$

where f(x,y) represents an original image, g(x,y) represents a degraded image, h(x,y) represents a PSF (point spread function), and *′ represents convolution. As the blur correction function 7422, for example, the abovementioned PSF is used. As will be described later, an image blur correction process is an image deconvolution process using the blur correction function 7422.

The time-series image 743 includes time-series image obtained by continuously capturing the liquid in the minutely vibrating container 2 with the camera device 6. In a case where there is suspended matter in the liquid within the container 2, the time-series image 743 contains an image of the suspended matter.

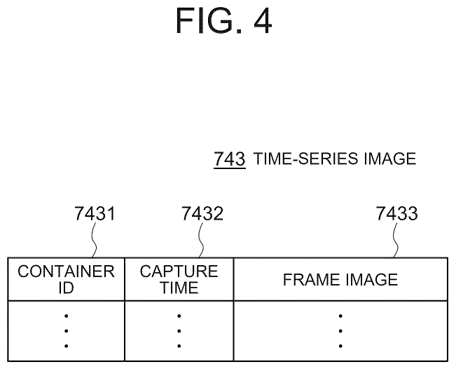

FIG. 4 shows an example configuration of the time-series image 743. In this example, the time-series image 743 is composed of an entry including container ID 7431, capture time 7432, and frame image 7433. In the field of the container ID 7431, an ID to uniquely identify the inspection target container 2 is set. The container ID can be a serial number assigned to the container 2, a barcode attached to the container 2, object fingerprint information collected from the cap of the container 2, or the like. In the fields of the capture time 7432 and the frame image 7433, the capture time and a frame image are set, respectively. The capture time 7432 is set to an accuracy (e.g., in milliseconds) that allows for distinguishment from the other adjacent frame image and identification. In the example of FIG. 4, the container ID is associated with each frame image 7433, but the container ID may be associated with each group of a plurality of frame images 7433.

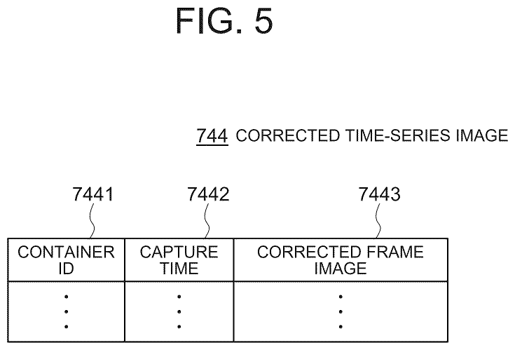

The corrected time-series image 744 includes a frame image after correction of image blur having occurred in the frame image 7433 included in the time-series image 743. FIG. 5 shows an example configuration of the corrected time-series image 744. In this example, the corrected time-series image 744 is composed of an entry including container ID 7441, capture time 7442, and corrected frame image 7443. In the fields of the container ID 7441 and capture time 7442, the same container ID 7431 and capture time 7432 as those of the correction target frame image 7433 are set. A blur-corrected frame image is set in the field of the corrected frame image 7443. In the example of FIG. 4, the container ID is associated with each corrected frame image 7443, but the container ID may be associated with each group of a plurality of corrected frame images 7443.

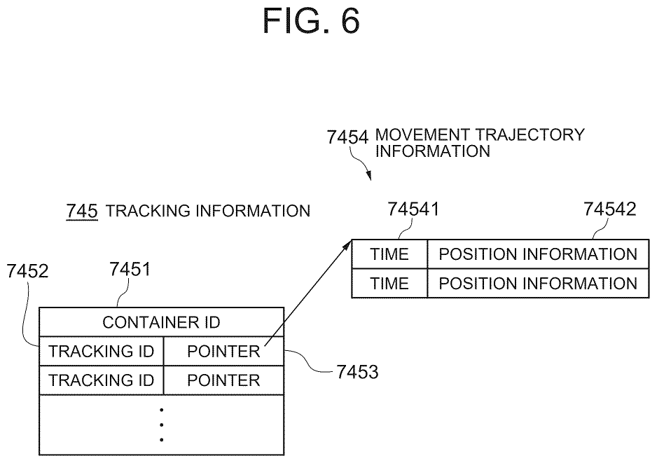

The tracking information 745 includes information corresponding to the result of detecting and tracking suspended matter present in the liquid within the container 2 based on the corrected time-series image 744. FIG. 6 shows an example configuration of the tracking information 745. In this example, the tracking information 745 is composed of an entry of container ID 7451 and an entry of a set of tracking ID 7452 and pointer 7453. In the entry of the container ID 7451, an ID to uniquely identify the container 2 is set. The entry including the set of the tracking ID 7452 and the pointer 7453 is set for each suspended matter to be tracked. In the field of the tracking ID 7452, an ID to identify the suspended matter to be tracked from other suspended matter in the same container 2. In the field of the pointer 7453, a pointer to the movement trajectory information 7454 of the suspended matter to be tracked is set.

The movement trajectory information 7454 is composed of an entry including a set of time 74541 and position information 74542. In the fields of the time 74541 and the position information 74542, the capture time and coordinate values indicating the position of the suspended matter to be tracked (e.g., position of the center of gravity of the suspended matter) at that capture time are set. The coordinate values may be, for example, coordinate values in a predetermined coordinate system. Further, the predetermined coordinate system may be a camera coordinate system centered on a camera, or may be a world coordinate system centered on a certain position in space. Entries in the movement trajectory information 7454 are arranged in order of the time 74541. The time 74541 of the first entry is the tracking start time. The time 74541 of the last entry is the tracking end time. The time 74541 of the entry other than the first and last is the tracking intermediate time.

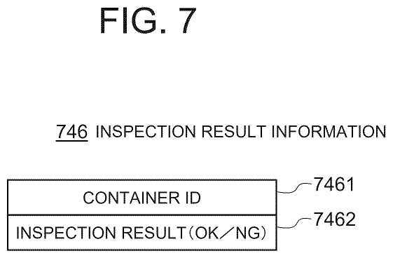

The inspection result information 746 represents the result of inspection of the container 2. FIG. 7 shows an example configuration of the inspection result information 746. In this example, the inspection result information 746 is composed of entries of the container ID 7461 and the inspection result 7462. In the entry for the container ID 7461, an ID to uniquely identify the container 2 having been inspected is set. In the entry of the inspection result 7462, an inspection result of OK (inspection passed) or NG (inspection failed) is set. OK indicates that no foreign matter has been detected in the liquid within the container. NG indicates that foreign matter has been detected in the liquid within the container.

Referring again to FIG. 3, the arithmetic processing unit 75 includes a processor such as a CPU (Central Processing Unit) and its peripheral circuits, and is configured to load and execute the program 741 from the storage unit 74, thereby making the above hardware and the program 741 cooperate to enable various processing units. The main processing units enabled by the arithmetic processing unit 75 include a preprocessing unit 751, a flow inducing unit 752, a minute-vibration applying unit 753, a detection unit 754, and an output control unit 755.

The preprocessing unit 751 is configured to perform preprocessing before the inspection of the container 2. In this example, the preprocessing unit 751 includes a minute-vibration trajectory determining unit 7511 and a blur correction function constructing unit 7512.

The minute-vibration trajectory determining unit 7511 is configured to determine a trajectory to minutely vibrate the container 2. That is to say, the minute-vibration trajectory determining unit 7511 determines a total of three parameters: a direction θ to minutely vibrate the container 2, a frequency f, and a displacement amount Δd. For example, the minute-vibration trajectory determining unit 7511 previously stores a direction correspondence table that associates a candidate of an appropriate direction θ with each type of container 2, and determines a direction θ corresponding to the input container type (syringe, etc.) through interactive processing with the operator via the operation input unit 72 and the screen display unit 73. In addition, the minute-vibration trajectory determining unit 7511 previously stores a frequency and displacement amount correspondence table that associates a candidate for an appropriate combination of frequency f and displacement amount Δd with each liquid viscosity category, and determines a combination of frequency f and displacement amount Δd corresponding to the input liquid viscosity category through interactive processing with the operator. Based on the minute-vibration trajectory determined by the minute-vibration trajectory determining unit 7511, the operator selects a minute-vibration application device 4 to be incorporated into the inspection system 1 from among a plurality of minute-vibration application devices prepared in advance, and implements it in the inspection system 1 before inspecting the container 2. Further, the minute-vibration trajectory determining unit 7511 stores the three parameters of the determined minute-vibration trajectory as the minute-vibration trajectory information 7421 into the storage unit 74.

The blur correction function constructing unit 7512 is configured to construct a blur correction function based on the minute-vibration trajectory information 7421 determined by the minute-vibration trajectory determining unit 7511. For example, when constructing the PSF in the aforementioned equation 1 as a blur correction function, the blur correction function constructing unit 7512 determines the PSF based on the direction θ and displacement amount Δd of the minute vibrations. The blur correction function constructing unit 7512 stores the constructed blur correction function as the blur correction function 7422 in the storage unit 74.

The flow inducing unit 752 is configured to send a flow start command to the flow induction device 3 through the communication I/F unit 71, thereby causing the flow induction device 3 to induce the flow of the liquid in the container 2. Further, the flow inducing unit 752 is configured to send a flow stop command to the flow induction device 3 through the communication I/F unit 71, thereby stopping the induction of the flow of the liquid by the flow induction device 3. Even if the induction of the flow of the liquid by the flow induction device 3 is stopped, the liquid inside container 2 continues to flow due to inertia for a while afterward.

The minute-vibration applying unit 753 is configured to send a minute-vibration start command to the minute-vibration application device 4 through the communication I/F unit 71, thereby causing the minute-vibration application device 4 to start minutely vibrating the container 2. Moreover, the minute-vibration applying unit 753 is configured to send a minute-vibration stop command to the minute-vibration application device 4 through the communication I/F unit 71, thereby stopping the minute vibrations of the container 2 by the minute-vibration application device 4.

The detecting unit 754 is configured to detect and track suspended matter present in the liquid in the time-series image obtained by continuously capturing the liquid in the container 2 minutely vibrated by the minute-vibration application device 4 with the camera device 6, and to detect the presence of foreign matter based on the movement trajectory of the tracked suspended matter. The detecting unit 754 includes a time-series image acquiring unit 7541, an image blur correcting unit 7542, and a determining unit 7543.

The time-series image acquiring unit 7541 is configured to send a capture start command to the camera device 6 through the communication I/F unit 71, thereby starting a process of continuously capturing the liquid flowing in the minutely vibrating container 2 under the illumination by the lighting device 5 with the camera device 6 at a predetermined frame rate. Further, the time-series image acquiring unit 7541 is configured to generate the time-series image 743 as shown in FIG. 4 from the captured time-series image and store it in the storage unit 74. Further, the time-series image acquiring unit 7541 is configured to send a capture end command to the camera device 6 through the communication I/F unit 71 and thereby ends the capture with the camera device 6.

The image blur correcting unit 7542 is configured to read out the time-series image 743 and the blur correction function 7422 from the storage unit 74, and perform a deconvolution process on each frame image 7433 in the time-series image 743 using the blur correction function 7422, as shown in the following equation;

$$D = I ⋆ H \qquad ( 2 )$$

where D is a corrected image, I is an input image, H is a blur correction function, and * is deconvolution. Additionally, the image blur correcting unit 7452 is configured to store the corrected time-series image 744 including the corrected frame images 7443 generated and obtained through the above process into the storage unit 74.

The determining unit 7543 is configured to read out the corrected time-series image 744 from the memory unit 74, detect and track suspended matter present in the liquid by processing such as binarization in the time-series corrected frame images 7443, and store the tracking information 745 including the movement trajectory of the tracked suspended matter into the storage unit 74. For example, the determining unit 7543 extracts all the corrected frame images from the corrected time-series image 744 shown in FIG. 5, and calculates all the movement trajectory information 7454 of the suspended matter present in the liquid within the container 2 from the time series of the extracted corrected frame images. Next, the determining unit 7543 calculates the tracking information 745 including the container ID 7451, a combination of the tracking ID 7452 and the pointer 7453, and the calculated movement trajectory information 7454 of the suspended matter, and stores into the storage unit 74.

Further, the determining unit 7543 is configured to detect the presence of foreign matter based on the tracking information 745. For example, the determining unit 7543 reads out the tracking information 745 from the storage unit 74 and, for each suspended matter tracking ID 7452 included in the tracking information 745, determines whether the suspended matter is a bubble or foreign matter based on the characteristics of the movement trajectory of the suspended matter represented by the movement trajectory information 7454 specified by the pointer 7453 corresponding to the tracking ID 7452. It can be determined whether the suspended matter is foreign matter or a bubble based on the movement trajectory of the suspended matter, because the characteristics of the movement trajectory of foreign matter in the liquid differ from those of bubbles. In other words, a bubble, which has a significantly lower specific gravity compared to liquid, exhibits a strong tendency to move in the opposite direction of gravity within the liquid. On the other hand, foreign matter, which has a higher specific gravity than a bubble does not show a strong tendency to move in the opposite direction of gravity in the liquid, but rather tends to move in the direction of gravity. From this, it can be determined that suspended matter that trace a path moving in the anti-gravity direction within liquid can be identified as a bubble, while suspended matter that trace a path moving in the gravity direction within liquid can be identified as foreign matter.

Further, the determining unit 7543 is configured to generate the inspection result information 746 based on the result of detection and store it into the storage unit 74. For example, when determining that at least one suspended matter is foreign matter, the determining unit 7543 creates the inspection result information 746 composed of the container ID 7461 and the inspection result 7462 of NG, and stores it into the storage unit 74. Moreover, when determining that all the suspended matter are bubbles, the determining unit 7543 creates the inspection result information 746 composed of the container ID 7461 and the inspection result 7462 of OK, and stores it into the storage unit 74.

The output control unit 755 is configured to read out the inspection result information 746 generated by the detecting unit 754 from the storage unit 74, and display it on the screen display unit 73 and/or transmit it to an external device that is not illustrated via the communication I/F unit 71.

Next, the overall operation of the inspection system 1 according to this example embodiment will be described.

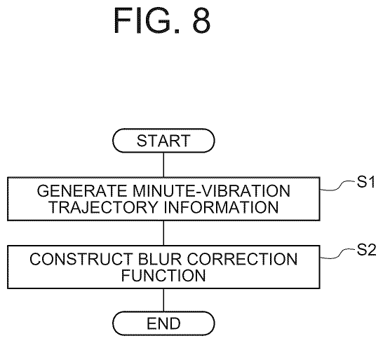

FIG. 8 is a flowchart illustrating an example of preprocessing in the inspection system 1. Prior to an actual inspection of the container 2, the inspection system 1 performs processing shown in FIG. 8 with the preprocessing unit 751. Referring to FIG. 8, the minute-vibration trajectory determining unit 7511 of the preprocessing unit 751 determines a total of three parameters: a direction θ, frequency f, and displacement amount Δd for minutely vibrating the container 2, and stores the determined three parameters of the minute-vibration trajectory as the minute-vibration trajectory information 7421 into the storage unit 74 (step S1).

Next, the blur correction function constructing unit 7512 of the preprocessing unit 751 constructs the blur correction function 7422 based on the minute-vibration trajectory information 7421 determined by the minute-vibration trajectory determining unit 7511, and stores it into the storage unit 74 (step S2).

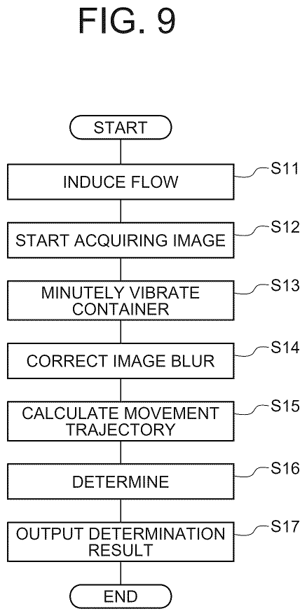

FIG. 9 is a flowchart showing an example of the inspection process performed by the inspection system 1 on the container to be inspected. Referring to FIG. 9, first, the flow inducing unit 752 sends a flow start command to the flow induction device 3 and thereby induces the flow of the liquid in the container 2 (step S11). Next, the time-series image acquiring unit 7541 of the detecting unit 754 sends a capture start command to the camera device 6 with the lighting device 5 turned on and thereby starts the process of continuously capturing the flowing liquid inside the container 2 at a predetermined frame rate (step S12). Moreover, the minute-vibration applying unit 753 sends a minute-vibration start command to the minute-vibration application device 4 simultaneously with or shortly before or after the start of the capture and thereby minutely vibrates the container 2 containing the flowing liquid along a predetermined minute-vibration trajectory (step S13). The flow inducing unit 752 sends a flow stop command to the flow induction device 3 in synchronization with the start of minute-vibration. As a result, the container 2 minutely vibrates in the stationary posture. However, the flow inducing unit 752 may be configured to send the flow stop command to the flow induction device 3 not at the start of the minute-vibration but at any point of time afterward. In other words, the flow inducing unit 752 may minutely vibrates the container 2 with tilted or swung

The time-series image acquiring unit 7541 of the detecting unit 754 receives the frame image 7433 captured by the camera device 6 from the camera device 6 in real-time through the communication I/F unit 71, appends the ID 7431 of the inspection target container 2 and the capture time 7432 to it, and adds it to the time-series image 743. In addition, as soon as the new frame image 7433 is added to the time-series image 743, the image blur correcting unit 7542 applies the blur correction function 7422 to the added frame image 7433 and performs blur correction thereon, and adds it to the corrected time-series image 744 as the corrected frame image 7443 (step S14).

As soon as the new corrected frame image 7443 is added to the corrected time-series image 744, the determining unit 7543 detects suspended matter from the added corrected frame image 7443, determines the identity with the previously detected suspended matter, and calculates the movement trajectory (step S15). Specifically, when detecting new suspended matter that is suspended in the liquid, the determining unit 7543 newly generates a set of tracking ID 7452 and pointer 7453, secures one entry in the movement trajectory information 7454 indicated by the pointer 7453, and sets the capture time 74541 of the frame in which the new suspended matter is detected and the position information 74542 of the detected suspended matter. On the other hand, when detecting not new suspended matter but suspended matter that has already been detected in the previously corrected frame image again, the determining unit adds one new entry to the movement trajectory information 7454 of the suspended matter determined to be identical, and sets the capture time 7454 of the current frame and the position information 74542 of the detected suspended matter.

As soon as the movement trajectory information 7454 is updated, the determining unit 7543 determines whether the suspended matter is a bubble or foreign matter based on the movement trajectory information 7454 (step S16). Then, at a point of time of determining that at least one suspended matter is not a bubble but foreign matter, the determining unit 7543 generates the inspection result information 746 including the inspection result 7462 of NG and stores it into the storage unit 74. At this point of time, the inspection system 1 ends the inspection of the inspection target container 2. Along with this, the minute-vibration applying unit 753 sends a vibration end command to the minute-vibration application device 4, and the time-series image acquiring unit 7541 sends a capture end command to the camera device 6.

On the other hand, in a case where there is no suspended matter determined to be foreign matter, the determining unit 7543 calculates the difference between the capture time 7442 at the top of the corrected time-series image 744 and the current time and, when the difference is less than an inspection time T seconds, waits for the movement trajectory information to be updated next, as it is still within the inspection time. Here, the inspection time T seconds can be determined before inspection by determining all possible types and sizes of foreign matter that may be mixed in, using the following method.

Determination Method 1: Mix foreign matter into the liquid within the container 2 indeed, measure time before all the foreign matter settle, and determine T seconds based on the measurement result.

Determination Method 2: When the viscosity of the liquid is known, calculate time before all the foreign matter settle based on the particle subsidence rate by the gravity sedimentation method, and determine T seconds based on the calculation result.

On the other hand, when the aforementioned difference is equal to or greater than the inspection time T seconds, the determining unit 7543 determines that no foreign matter has been detected, generates the inspection result information 746 including the inspection result 7462 of OK, and stores it into the storage unit 74. Then, at this point of time, the inspection system 1 ends the inspection of the inspection target container 2. Along with this, the minute-vibration applying unit 753 sends a vibration end command to the minute-vibration application device 4, and the time-series image acquiring unit 7541 sends a capture end command to the camera device 6.

When the inspection result information 746 is created by the determining unit 7543, the output control unit 755 displays the inspection result information 746 on the screen display unit 73, and/or transmits it to an external device through the communication I/F unit 71 (step S17).

Thus, this example embodiment includes the flow inducing part 752 that flows the liquid within the container 2, the minute-vibration applying unit 753 that minutely vibrates the container 2 containing the flowing liquid, and the detecting unit 754 that detects and tracks suspended matter present in the liquid in the time-series image obtained by continuously capturing the liquid within the container 2 during minute vibrations with a camera device 6 and detects the presence of foreign matter based on the movement trajectory of the tracked suspended matter. Therefore, it is possible to observe the behavior of suspended matter while the viscosity of the liquid sealed in the container 2 is reduced, which can shorten the time before the behavior characteristic to foreign matter, such as subsidence, is observed. This improves the inspection efficiency.

Further, this example embodiment includes the image blur correcting unit 7542 that corrects blur occurring in an image captured by the camera device 6 due to the minute vibrations of the container 2. As a result, it is possible to accurately detect and track suspended matter in the liquid without being affected by minute vibrations.

### Second Example Embodiment

Next, an inspection system 1A according to a second example embodiment of the present invention will be described. The inspection system 1A is different from the abovementioned inspection system 1 in dividing inspection into a non-vibration inspection to inspect the container 2 without minutely vibrating and a vibration inspection to inspect the container 2 with minutely vibrating and, when detecting foreign matter during the non-vibration inspection, skipping the vibration inspection. In the following, the inspection system 1A will be described focusing on the difference from the inspection system 1.

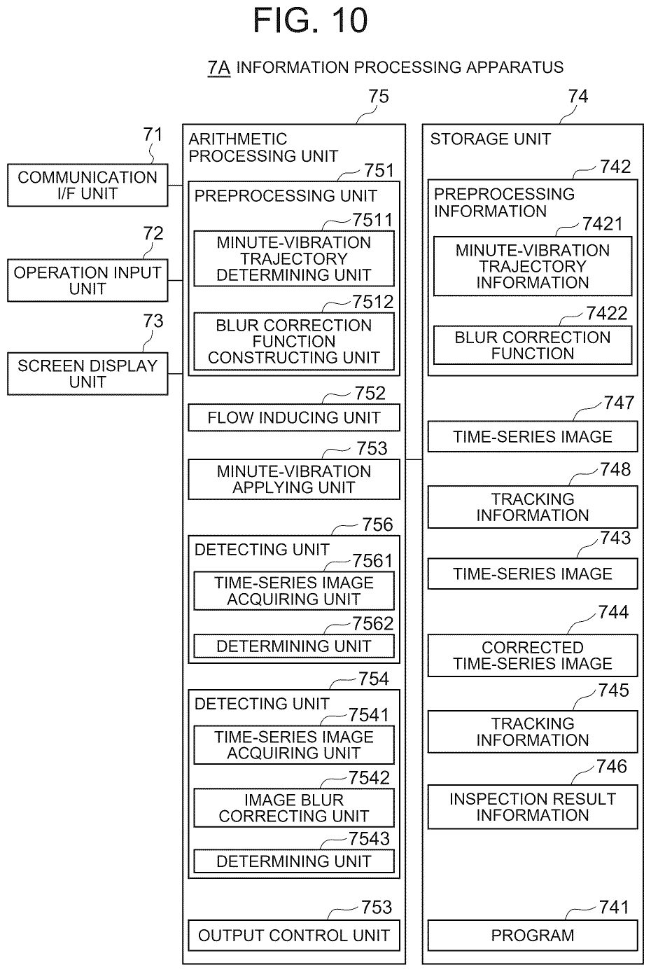

FIG. 10 is a block diagram showing an example of an information processing apparatus 7A used in the inspection system 1A, the same reference numerals as in FIG. 3 denote the same parts, reference numeral 747 denotes a time-series image, reference numeral 748 denotes tracking information, reference numeral 756 denotes a detecting unit, reference numeral 7561 denotes a time-series image acquiring unit, and reference numeral 7562 denotes a determining unit.

The time-series image 747 includes a time-series image obtained by continuously capturing the liquid within the container 2 that is not minutely vibrating with the camera device 6. In a case where there is suspended matter in the liquid within the container 2, the time-series image 747 shows an image of the suspended matter. The configuration of the time-series image 747 is the same as that of the time-series image 743 shown in FIG. 4. However, there is no image blur due to minute vibrations in the frame images of the time-series image 747.

The tracking information 748 includes information corresponding to the result of detecting and tracking suspended matter present in the liquid within the container 2 based on the time-series image 747. The configuration of the tracking information 748 is the same as the configuration of the tracking information 745 shown in FIG. 6.

The detecting unit 756 is configured to detect and track suspended matter present in the liquid in the time-series image obtained by continuously capturing the liquid within the container 2 that is not minutely vibrating with the camera device 6, and detect the presence of foreign matter based on the movement trajectory of the tracked suspended matter. The detecting unit 756 includes a time-series image acquiring unit 7561 and a determining unit 7562.

The time-series image acquiring unit 7561 is configured to send a capture start command to the camera device 6 through the communication I/F unit 71 and thereby causes the camera device 6 to start a process to continuously capture the liquid flowing inside the container 2 under the illumination of the lighting device 5 at a predetermined frame rate. Further, the time-series image acquiring unit 7561 is configured to generate the time-series image 747 as shown in FIG. 4 from a time-series image obtained by capture and store it into the storage unit 74. Further, the time-series image acquiring unit 7561 is configured to send a capture end command to the camera device 6 through the communication I/F unit 71 and thereby end the capture by the camera device 6.

The determining unit 7562 is configured to read out the time-series image 747 from the storage unit 74, detect and track suspended matter present in the liquid in the time-series frame images 7433, and store the tracking information 748 including the movement trajectory of the tracked suspended matter into the storage unit 74.

Additionally, the determining unit 7562 is configured to detect the presence of foreign matter based on the tracking information 748. For example, the determining unit 7562 reads out the tracking information 748 from the storage unit 74 and, for each tracking ID 7452 of suspended matter included in the tracking information 748, determines whether the suspended matter is a bubble or foreign matter based on the characteristic of the movement trajectory of suspended matter represented by the movement trajectory information 7454 specified by the pointer 7453 corresponding to the tracking ID 7452.

Further, the determining unit 7562 is configured to generate the inspection result information 746 when detecting foreign matter and store it into the storage unit 74. For example, when determining that at least one suspended matter is foreign matter, the determining unit 7562 creates the inspection result information 746 composed of the container ID 7461 and the inspection result 7462 of NG, and stores it into the storage unit 74. On the other hand, in a case where no foreign matter is detected during a period of an inspection time T1 of a first half process, the determining unit 7562 ends the detection process by the detecting unit 756. At this time, the detection process shifts to the detecting unit 754.

Next, the overall operation of the inspection system 1A according to this example embodiment will be described, focusing on the difference from the inspection system 1.

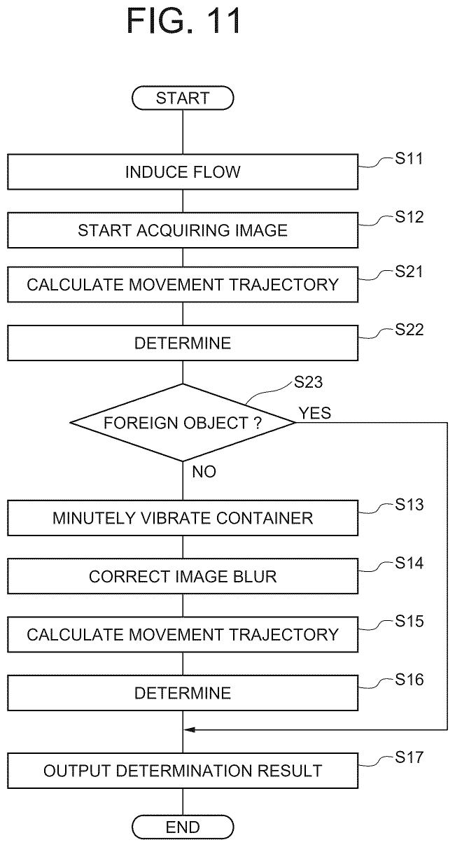

FIG. 11 is a flowchart showing an example of an inspection process performed by the inspection system 1A on an inspection target container. Referring to FIG. 11, first, the flow inducing unit 752 sends a flow start command to the flow induction device 3 and thereby induces the flow of liquid in the container 2 (step S11). Next, the time-series image acquiring unit 7561 of the detecting unit 756 sends a capture start command to the camera device 6 with the lighting device 5 turned on and thereby starts a process to continuously capture the flowing liquid inside the container 2 at a predetermined frame rate (step S12). At this time, since the minute-vibration application device 4 is not activated, the container 2 containing the flowing liquid is not minutely vibrating. In other words, the non-vibration inspection is conducted first.

The time-series image acquiring unit 7561 of the detecting unit 756 receives the frame image 7433 captured by the camera device 6 in real time through the communication I/F unit 71, appends the ID 7431 of the inspection target container 2 and the capture time 7432 to it, and adds it to the time-series image 747. As soon as the new frame image 7433 is added to the time-series image 747, the determining unit 7562 detects suspended matter from the added frame image 7433, determines the identity with the previously detected suspended matter, and calculates the movement trajectory (step S21). Specifically, when detecting new suspended matter that is suspended in the liquid, the determining unit 7562 newly generates a pair of tracking ID 7452 and pointer 7453, secures one entry in the movement trajectory information 7454 indicated by the pointer 7453, and sets the capture time 74541 of the frame where the new suspended matter is detected and the position information 74542 of the detected suspended matter. On the other hand, when suspended matter that has already been detected in the previous frame image is detected again, rather than being new suspended matter, one new entry is added to the movement trajectory information 7454 of the suspended matter determined to be the same, and the capture time 7454 of the current frame and the position information 74542 of the detected suspended matter are set.

The determining unit 7562 determines whether the suspended matter is a bubble or foreign matter based on the movement trajectory information 7454 as soon as the movement trajectory information 7454 is updated (step S22). Then, at a point of time when determining that at least one suspended matter is not a bubble but foreign matter (YES in step S23), the determining unit 7562 generates the inspection result information 746 including the inspection result 7462 of NG and stores it into the storage unit 74 (step S17). Then, at this point of time, the inspection system 1A ends the inspection of the inspection target container 2. In other words, the inspection system 1A skips the vibration inspection and ends the inspection. In accordance with this, the time-series image acquiring unit 7561 sends a capture end command to the camera device 6.

On the other hand, in a case where there is no suspended matter determined as foreign matter, the determining unit 7562 calculates the difference between the capture time 7432 at the top of the time-series image 743 and the current time and, when this difference is less than the non-vibration inspection time T1 seconds, the determining unit 7562 waits for the movement trajectory information to be updated next, as it is still within the non-vibration inspection period. Here, the non-vibration inspection time T1 seconds can be determined before the inspection using the following method by determining the types and sizes of all possible foreign matter that will immediately settle (such as glass fragments or metal pieces) (hereinafter referred to as heavyweight foreign matter) among all the foreign matter that may be mixed in.

Determination Method 1: Mix heavyweight foreign matter into the liquid in the container 2 indeed, measure time before all the heavyweight foreign matter settle, and determine T1 seconds based on the measurement result.

Determination Method 2: When the viscosity of the liquid is known, calculate time before the heavyweight foreign matter settle based on the particle subsidence rate by the gravity sedimentation method, and determine T1 seconds based on the calculation result.

On the other hand, when the abovementioned difference is equal to or greater than the non-vibration inspection time T1 seconds, the determining unit 7543 ends the detection process by the detecting unit 756. In other words, the inspection system 1A ends the non-vibration inspection and immediately starts the vibration inspection.

First, the minute-vibration applying unit 753 sends a minute-vibration start command to the minute-vibration application device 4 and thereby minutely vibrates the container 2 containing the flowing liquid along a predetermined minute-vibration trajectory (step S13). Moreover, the time-series image acquiring unit 7541 of the detecting unit 754 receives the frame image 7433 captured by the camera device 6 in real time through the communication I/F unit 71, appends the ID 7431 of the inspection target container 2 and the capture time 7432 to it, and adds it to the time-series image 743. Moreover, as soon as the new frame image 7433 is added to the time-series image 743, the image blur correcting unit 7542 applies the blur correction function 7422 to the added frame image 7433 and performs blur correction, and adds it to the corrected time-series image 744 as the corrected frame image 7443 (step S14).

As soon as the new corrected frame image 7443 is added to the corrected time-series image 744, the determining unit 7543 detects suspended matter from the added corrected frame image 7443, determines the identity with previously detected suspended matter, and calculates the movement trajectory (step S15). Moreover, as soon as the movement trajectory information 7454 is updated, the determining unit 7543 determines whether the suspended matter is a bubble or foreign matter based on the movement trajectory information 7454 (step S16). Then, at a point of time when determining that at least one suspended matter is not a bubble but foreign matter, the determining unit 7543 generates the inspection result information 746 including the inspection result 7462 of NG, and stores it into the storage unit 74 (step S17). Then, at this point of time, the inspection system 1 ends the inspection of the inspection target container 2. In accordance with this, the minute-vibration applying unit 753 sends a vibration end command to the minute-vibration application device 4, and the time-series image acquiring unit 7541 sends a capture end command to the camera device 6.

On the other hand, in a case where there is no suspended matter determined as foreign matter, the determining unit 7543 calculates the difference between the capture time 7442 at the top of the corrected time-series image 744 and the current time and, when the difference is less than vibration inspection time T2 seconds, the determining unit 7543 waits for the movement trajectory information to be updated next, as it is still within the vibration inspection period. Here, the vibration inspection time T2 seconds can be determined before the inspection by the following method, by determining the types and sizes of foreign matter (hereinafter referred to as lightweight foreign matter) other than foreign matter with characteristics that immediately settle (such as glass fragments or metal fragments) among all foreign matter that may be mixed in.

Determination Method 1: Mix lightweight foreign matter into the liquid in the container 2 indeed, measure time before all the lightweight foreign matter settle, and determine the T2 seconds based on the measurement result.

Determination Method 2: When the viscosity of the liquid is known, calculate time before all the lightweight foreign matter settle based on the particle subsidence rate using the gravity sedimentation method, and determine the T2 seconds based on the calculation result.

On the other hand, when the aforementioned difference is equal to or greater than the vibration inspection time T2 seconds, the determining unit 7543 determines that no foreign matter was detected, generates the inspection result information 746 including the inspection result 7462 of OK, and stores it into the storage unit 74. Then, at this point of time, the inspection system 1 ends the inspection of the inspection target container 2. In accordance with this, the minute-vibration applying unit 753 sends a vibration end command to the minute-vibration application device 4, and the time-series image acquiring unit 7541 sends a capture end command to the camera device 6.

When the inspection result information 746 is created by the determining unit 7543, the output control unit 755 displays the inspection result information 746 on the screen display unit 73, and/or transmits it to an external device through the communication I/F unit 71 (step S17).

Thus, in this example embodiment, the inspection is divided into the non-vibration inspection to inspect without minutely vibrating the container 2 and the vibration inspection to inspect while minutely vibrating, and the non-vibration inspection is conducted first to check for the presence of heavyweight foreign matter. Heavyweight foreign matter basically tends to subside immediately even in the original viscous liquid that is not vibrated, as it is a type of foreign matter with characteristics that allow it to settle immediately. Therefore, for the container 2 that contains heavyweight foreign matter, it is possible to detect the foreign matter early only by the non-vibration inspection. Here, by applying vibrations from the beginning to reduce the viscosity of the liquid as in the inspection system 1, heavyweight foreign matter can be made to subside earlier. However, depending on the frame rate of the camera device 6, it may be difficult or impossible to track foreign matter that subsides too quickly. This is because the travel distance of suspended matter between consecutive frame images becomes too large. In particular, as will be described later, in the case of correcting image blur by setting the capture period of the camera device 6 that captures the container 2 during minute vibrations, to an integer multiple of the minute-vibration period, there is a strong tendency for the capture period to become longer, resulting in a larger travel distance of suspended matter between consecutive frame images. The inspection system 1A of this example embodiment is suitable for such cases, for example.

Further, in this example embodiment, in a case where foreign matter is detected in the non-vibration inspection, the vibration inspection is skipped. Furthermore, in the vibration inspection, the behavior of suspended matter is observed with the reduced viscosity of the liquid sealed in the container 2, so that it is possible to shorten time before behavior characteristic of foreign matter is observed, such as subsidence. This improves the inspection efficiency.

### Third Example Embodiment

Next, an inspection system according to a third example embodiment of the present invention (referred to as an inspection system 1B) will be described. The inspection system 1B differs from the first or second example embodiment in setting the capture period (1/frame rate) of the camera device 6 for capturing the liquid in the container 2 during minute-vibrations to an integer multiple (1 times, 2 times, . . . ) of the minute-vibration period (1/frequency f), while the rest is the same as the first or second example embodiment.

By setting the capture cycle of the camera device 6 that captures the container 2 during minute-vibrations to an integer multiple of the minute-vibration cycle, the motion caused by minute-vibrations is captured at the same pixel position. Therefore, it is possible to separate the movement of suspended matter in the liquid from the movement in minute-vibrations. In other words, according to the inspection system 1B, it is possible to capture in a state where the minutely vibrating container 2 is apparently stationary in the same position. Therefore, it is possible to accurately execute the detection and tracking of suspended matter in the liquid without being affected by minute-vibrations. Meanwhile, in the inspection system 1B, the image blur correcting unit 7542 may be excluded or included.

### Fourth Example Embodiment

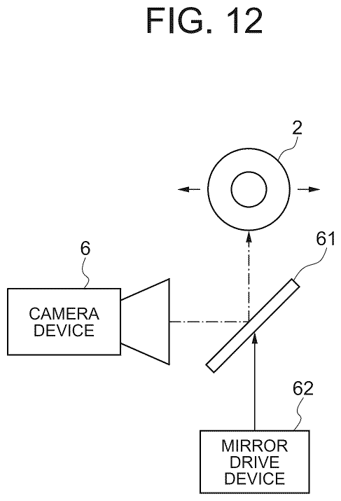

Next, an inspection system 1C according to a fourth example embodiment of the present invention will be described. FIG. 12 is an essential part configuration diagram of the inspection system 1C. Referring to FIG. 12, the inspection system 1C differs from the first to third example embodiments in that it further includes a mirror 61 that reflects the image of the container 2 and inputs it to the camera device 6, and a mirror drive unit 62 that drives the mirror 61 in accordance with the minute vibrations of the container 2, while the rest is the same as in the first to third example embodiments. In the example shown in FIG. 12, the minute-vibration trajectory of the container 2 is a straight line, but the minute-vibration trajectory may also be a curved line such as an arc or an ellipse.

By driving the mirror 61 that reflects the image of the container 2 and inputs it into the camera device 6, in accordance with the minute vibrations of the container 2, it is possible to capture in a state where the minutely vibrating container 2 is apparently stationary at the same position. Therefore, it is possible to accurately detect and track suspended matter in the liquid without being affected by minute vibrations. Meanwhile, in the inspection system 1C, the image blur correcting unit 7542 may be excluded or may be included.

### Fifth Example Embodiment

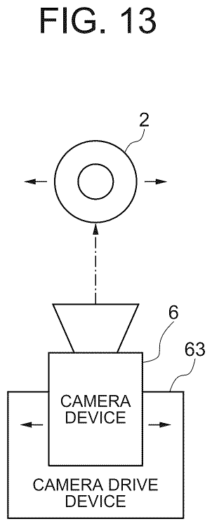

Next, an inspection system 1D according to a fifth example embodiment of the present invention will be described. FIG. 13 is an essential part configuration diagram of the inspection system 1D. Referring to FIG. 13, the inspection system 1D differs from the first to third example embodiments in that it further includes a camera drive unit 63 that drives (minutely vibrates) the camera device 6 in response to minute vibrations of the container 2, while the rest is the same as in the first to third example embodiments. In the example shown in FIG. 13, the minute-vibration trajectory of the container 2 is a straight line, but it may also be a curved line such as an arc or an ellipse. Additionally, the camera drive unit 63 may be configured to minutely vibrates the container 2 along with the camera device 6. In other words, the camera drive unit 63 and the minute-vibration application device 4 can be made common.

By driving the camera device 6 in accordance with the minute vibrations of the container 2, it is possible to capture in a state where the minutely vibrating container 2 is apparently stationary in the same position. Therefore, it is possible to accurately detect and track suspended matter in the liquid without being affected by minute vibrations. In the inspection system 1D, the image blur correcting unit 7542 may be excluded or may be included.

### Sixth Example Embodiment

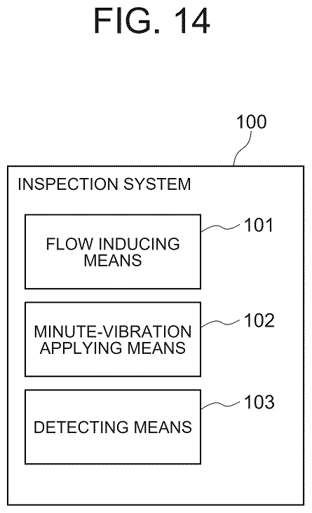

Next, a sixth example embodiment of the present invention will be described. FIG. 14 is a block diagram of an inspection system 100 according to this example embodiment. This example embodiment provides an overview of the inspection system described above.

Referring to FIG. 14, the inspection system 100 is an inspection system that inspects the presence of foreign matter in a liquid sealed in a container, and includes a flow inducing means 101, a minute-vibration applying means 102, and a detecting means 103.

The flow inducing means 101 is configured to flow the liquid inside the container. The flow inducing means 101 can be configured, for example, in the same manner as the flow inducing unit 752 shown in FIG. 3 or FIG. 10. The minute-vibration applying means 102 is configured to minutely vibrate the container containing the flowing liquid. The minute-vibration applying means 102 can be configured, for example, in the same manner as the minute-vibration applying unit 753 shown in FIG. 3 or FIG. 10. The detecting means 103 is configured to detect and track suspended matter present in the liquid in a time-series image obtained by continuously capturing the liquid inside the minutely vibrating container with a camera, and to detect the presence of foreign matter based on the movement trajectory of the tracked suspended matter. The detecting means 103 can be configured, for example, in the same manner as the detecting unit 754 shown in FIG. 3 or FIG. 10.

The inspection system 100 thus configured functions as follows. First, the flow inducing means 101 flows the liquid inside the container. Next, the minute-vibration applying means 102 minutely vibrates the container in which the liquid is flowing. Next, the detecting means 103 detects and tracks suspended matter present in the liquid in a time-series image obtained by continuously capturing the liquid inside the minutely vibrating container with the camera, and detects the presence of foreign matter based on the movement trajectory of the tracked suspended matter.

According to the inspection system 100 configured and operating as described above, the behavior of suspended matter can be observed in a state where the viscosity of the liquid sealed in the container is reduced by minute vibrations, so that the time before behavior specific to foreign matter such as subsidence is observed can be shortened and the inspection efficiency increases.

Although the present invention has been described above with reference to the above example embodiments, the present invention is not limited to the example embodiments described above. The configuration and details of the present invention can be changed in various manners that can be understood by one skilled in the art within the scope of the present invention.

For example, the information processing apparatus may use a GPU (Graphic Processing Unit), a DSP (Digital Signal Processor), an MPU (Micro Processing Unit), an FPU (Floating Number Processing Unit), a PPU (Physics Processing Unit), a TPU (Tensor Processing Unit), a quantum processor, a microcontroller, or a combination of these, instead of the abovementioned CPU.

### INDUSTRIAL AVAILABILITY

The present invention can be widely used in the field of inspection of the presence of foreign matter in a liquid sealed in container such as a syringe and a vial.

The whole or part of the above example embodiments can be described as the following supplementary notes, but is not limited to the following.

### [Supplementary Note 1]

An inspection system inspecting presence or absence of foreign matter in a liquid sealed in a container, the inspection system comprising:
a flow inducing means for causing the liquid in the container to flow;
a minute vibration applying means for causing the container where the liquid is flowing to minutely vibrate; and
a first detecting means for detecting and tracking suspended matter present in the liquid in the minutely vibrating container in a time-series image obtained by continuously capturing the liquid with a camera, and detecting presence or absence of foreign matter based on a movement trajectory of the tracked suspended matter.

### [Supplementary Note 2]

The inspection system according to supplementary note 1, further comprising
a second detecting means for, before the container is caused to minutely vibrate, detecting and tracking suspended matter present in the flowing liquid in the container in the time-series image obtained by continuously capturing the liquid with the camera, and detecting presence or absence of foreign matter based on a movement trajectory of the tracked suspended matter,
wherein when foreign matter is detected by the second detecting means, the detection by the first detecting means is skipped.

### [Supplementary Note 3]

The inspection system according to supplementary note 1, further comprising
a correcting means for correcting a blur occurring in the time-series image due to the minute vibration.

### [Supplementary Note 4]

The inspection system according to supplementary note 3, wherein
the correcting means performs deconvolution of the image using a blur correction function constructed based on a trajectory of the minute vibration.

### [Supplementary Note 5]

The inspection system according to supplementary note 4, wherein
the blur correction function is a point spread function.

### [Supplementary Note 6]

The inspection system according to supplementary note 4, further comprising
a means for generating the blur correction function based on the trajectory of the minute vibration.

### [Supplementary Note 7]

The inspection system according to supplementary note 1, wherein
the camera captures at a period that is an integer multiple of a vibration period of the minute vibration.

### [Supplementary Note 8]

The inspection system according to supplementary note 1, further comprising
a mirror that reflects an image of the container and makes the image enter the camera, and a mirror drive unit that drives the mirror in accordance with the minute vibration of the container.

### [Supplementary Note 9]

The inspection system according to supplementary note 1, further comprising
a camera drive unit that drives the camera in accordance with the minute vibration of the container.

### [Supplementary Note 10]

The inspection system according to any of supplementary notes 1 to 9, wherein
the liquid is a liquid exhibiting a non-Newtonian viscosity property.

### [Supplementary Note 11]

An inspection method for inspecting presence or absence of foreign matter in a liquid sealed in a container, the inspection method comprising:
causing the liquid in the container to flow;
causing the container where the liquid is flowing to minutely vibrate; and
detecting and tracking suspended matter present in the liquid in the minutely vibrating container in a time-series image obtained by continuously capturing the liquid with a camera, and detecting presence or absence of foreign matter based on a movement trajectory of the tracked suspended matter.

### [Supplementary Note 12]

A non-transitory computer-readable recording medium where a program is recorded, the program comprising instructions for causing a computer inspecting presence or absence of foreign matter in a liquid sealed in a container to execute processes to:
cause the liquid in the container to flow;
cause the container where the liquid is flowing to minutely vibrate; and
detect and track suspended matter present in the liquid in the minutely vibrating container in a time-series image obtained by continuously capturing the liquid with a camera, and detect presence or absence of foreign matter based on a movement trajectory of the tracked suspended matter.

### REFERENCE SIGNS LIST

100 inspection system
101 flow inducing means
102 minute-vibration applying means
103 detecting means

What is claimed is:

1. An inspection apparatus inspecting presence or absence of foreign matter in a liquid sealed in a container, the inspection apparatus comprising:
a memory containing program instructions; and
a processor coupled to the memory, wherein the processor is configured to execute the program instructions to:
cause the liquid in the container to flow;
cause the container where the liquid is flowing to minutely vibrate; and
perform a first detection process of detecting and tracking suspended matter present in the liquid in the minutely vibrating container in a time-series image obtained by continuously capturing the liquid with a camera, and detecting presence or absence of foreign matter based on a movement trajectory of the tracked suspended matter.

2. The inspection system apparatus according to claim 1, wherein the processor is further configured to execute the program instructions to
before the container is caused to minutely vibrate, perform a second detection process of detecting and tracking suspended matter present in the flowing liquid in the container in the time-series image obtained by continuously capturing the liquid with the camera, and detecting presence or absence of foreign matter based on a movement trajectory of the tracked suspended matter; and
when foreign matter is detected by the second detecting means, skip the first detection process.

3. The inspection apparatus according to claim 1, wherein the processor is further configured to execute the program instructions to
correct a blur occurring in the time-series image due to the minute vibration.

4. The inspection apparatus according to claim 3, wherein
in the correction, deconvolution of the image is performed using a blur correction function constructed based on a trajectory of the minute vibration.

5. The inspection apparatus according to claim 4, wherein
the blur correction function is a point spread function.

6. The inspection apparatus according to claim 4, wherein the processor is further configured to execute the program instructions to
generate the blur correction function based on the trajectory of the minute vibration.

7. The inspection apparatus according to claim 1, wherein
the camera captures at a period that is an integer multiple of a vibration period of the minute vibration.

8. The inspection apparatus according to claim 1, further comprising
a mirror that reflects an image of the container and makes the image enter the camera, wherein the processor is further configured to execute the program instructions to
drive the mirror in accordance with the minute vibration of the container.

9. The inspection apparatus according to claim 1, wherein the processor is further configured to execute the program instructions to
drive the camera in accordance with the minute vibration of the container.

10. The inspection apparatus according to claim 1, wherein
the liquid is a liquid exhibiting a non-Newtonian viscosity property.

11. An inspection method by a computer for inspecting presence or absence of foreign matter in a liquid sealed in a container, the inspection method comprising:
by the computer, causing the liquid in the container to flow;
by the computer, causing the container where the liquid is flowing to minutely vibrate; and
by the computer, detecting and tracking suspended matter present in the liquid in the minutely vibrating container in a time-series image obtained by continuously capturing the liquid with a camera, and detecting presence or absence of foreign matter based on a movement trajectory of the tracked suspended matter.

12. A non-transitory computer-readable recording medium where a program is recorded, the program comprising instructions for causing a computer inspecting presence or absence of foreign matter in a liquid sealed in a container to execute processes to:
cause the liquid in the container to flow;
cause the container where the liquid is flowing to minutely vibrate; and
detect and track suspended matter present in the liquid in the minutely vibrating container in a time-series image obtained by continuously capturing the liquid with a camera, and detect presence or absence of foreign matter based on a movement trajectory of the tracked suspended matter.
